(19) United States
(12) Patent Application Publication
(10) Pub. No.: US 2008/0272307 A1
(43) Pub. Date: Nov. 6, 2008

(54) Radiation Detector

(75) Inventors: William I. Helsby, Widnes (GB); Nicholas J. Glague, Warrington (GB); Robert A. Lewis, Victoria (AU); Christopher J. Hall, Cheshire (GB); Brian T. Parker, Denbighshire (GB)

Correspondence Address: MORRISON & FOERSTER LLP, 1650 TYSONS BOULEVARD, SUITE 400, MCLEAN, VA, 22102, US

(73) Assignee: Science and Technology Facilities Council

(21) Appl. No.: 11/885,653

(22) PCT Filed: Mar. 24, 2006
(86) PCT No.: PCT/GB2006/001100

§ 371 Date: Jun. 9, 2008

(30) Foreign Application Priority Data
Mar. 29, 2005 (GB) 0506203.9

(51) Int. Cl. G01T 1/185

(52) U.S. Cl. 250/389

(57) ABSTRACT

Devices and methods for detecting radiation are described. A detector for detecting radiation comprises a housing containing an ionisable gas, an array of anode wires extending substantially in a first plane, and arranged to be held at a first potential for attracting electrons, and at least one cathode wire spaced in a predetermined relationship from the anode wires, arranged to be held at a second, lower potential. The detector further comprises at least one additional electrode positioned adjacent a periphery of the array of anode wires, and arranged to be held at a third potential, greater than the second potential. A window for a radiation detector is described and comprising a housing containing an ionisable gas is also described. The window comprises a layer formed of an electrically conductive material forming an electrode, a layer formed of a plastic, arranged to support the layer formed of electrically conductive material, and a layer of gas impermeable material.

The present invention relates to a radiation detector incorporating an ionisable gas. Embodiments of the present invention are particularly suitable for, but not limited to, use as multi-wire proportional counters (MWPC). The present invention also relates to a window for use in a radiation detector containing an ionisable gas.

U.S. Pat. No. 3,911,279 describes a position sensitive multi-wire proportional counter with integral delay line. The counter can be utilised to obtain positional data with respect to ionising radiation.

The counter is filled with a gas which ionises upon interaction with ionising radiation (i.e. an ionisable gas). The device includes a plurality of anode wires, and at least one cathode wire spaced in a predetermined relationship from the anode wires.

The gas in the detection volume is ionised by the radiation, producing free electrons. The electrons drift towards the anode. As the electrons near the positive anode, the electrons are accelerated towards the anode. As the anode is held at a relatively high potential, these electrodes ionise further gas molecules (secondary ionisation), resulting in a multiplication of the total number of free electrons as the secondary electrons are released. This multiplication process is typically termed an electron avalanche. The majority of the electrons created by this ionisation process are collected on the anode, leaving a net positive charge in the gas due to the positive ions. This positive charge induces a voltage on the cathode wires, which is inversely related to the distance of the cathode wire from the positive charge. The resulting voltage profile is then time-analysed, with the position of the ionising radiation thereby being determined.

The greater the electric field strength, the greater the number of secondary electrons that will be released i.e. the greater the multiplication of the initial number of free electrons within the radiation detector. Therefore, it is desirable to have a relatively high electric field. However, the stronger the electric field, the more likely sparking is to occur within the detector. Sparking results in errors within the detected data, as well as reducing the life span of the detector. Sparking is the appearance of a spark discharge within the detector, due to localised electrical breakdown across regions of the ionisable gas.

Furthermore, to derive accurate position data, it is desirable that the electric field distribution is uniform through the drift region. An uneven electric field distribution can result in a decreased accuracy in the detector output e.g. it can give anomalous results in respect of the distribution of electrons incident at different positions on the anode wires.

Radiation detectors including an ionisable gas typically possess a window, to allow radiation into the housing containing the ionisable gas and to prevent the escape of the gas from the housing. Typically, such windows are formed from beryllium, particularly in X-ray detectors. The beryllium allows the transmission of X-rays. The beryllium is held at a negative potential relative to the cathode wires. Thus, an electric “drift” field is created between the negative voltage on the inner surface of the window, and the cathode wire(s), which are held at a more positive voltage (e.g. zero volts). The electrons move under the influence of this drift field, towards the cathode and the adjacent anode.

The electrical conductivity of beryllium is approximately 3.1×10⁵ cm⁻¹Ω⁻¹. However, beryllium is poisonous and brittle. Beryllium is therefore a difficult material to handle, as well as to machine into the desired shape for use as a window.

It is an aim of embodiments of the present invention to provide a radiation detector comprising an ionisable gas, that addresses one or more problems of the prior art, whether referred to herein or otherwise.

It is an aim of the embodiments of the present invention to provide a window for use in a radiation detector that comprises an ionisable gas, that substantially addresses one or more problems of the prior art, whether referred to herein or otherwise.

According to a first aspect of the present invention there is provided a detector for detecting radiation, comprising: a housing containing an ionisable gas; an array of anode wires extending substantially in a first plane, and arranged to be held at a first potential for attracting electrons; at least one cathode wire spaced in a predetermined relationship from the anode wires, and arranged to be held at a second, lower potential; wherein the detector further comprises at least one additional electrode positioned adjacent a periphery of the array of anode wires, and arranged to be held at a third potential, greater than the second potential.

The provision of such an additional electrode facilitates the creation of a substantially uniform electric field distribution in the drift field region. This provides an improvement in the accuracy of the detector. Further, providing a more uniform electric field distribution adjacent the anode decreases the likelihood of sparking occurring.

Said third potential may be less than or substantially equal to said first potential.

Said at least one additional electrode may comprise a first additional electrode positioned adjacent one edge of the array of anode wires, and a second additional electrode positioned adjacent the opposite edge of said array.

Said at least one additional electrode may extend substantially within the first plane.

Said anode wires may extend in a substantially parallel direction, and said at least one additional electrode may extend longitudinally in a direction parallel to the anode wires.

Said anode wires may extend in a substantially parallel direction, and said at least one additional electrode may extend longitudinally in a direction perpendicular to the anode wires.

The anode wires located at each end of the array may be thicker than the anode wires located at the centre of the array.

The anode wires located at each end of the array may have a thickness at least 50% greater than the thickness of the anode wires located at the centre of the array.

The anode wires located at each end of the array may be held under greater tension than the wires located at the centre of the array.

The detector may comprise at least one frame supporting at least one of said wires, the supported wire being coupled to the frame via a member coupled to the frame, the member comprising a body portion with a projection extending towards the centre of the length of supported wire.

The detector may comprise at least one frame supporting at least one of said wires, the frame being formed of an electrically insulative material, the separation between said supported wire and an adjacent surface of the frame tapering towards an adjacent end of said wire.

Said frame may support at least one of the cathode wires, with the portion of the frame adjacent a periphery of the anode wire array presenting at least one of a substantially planar surface to the anode and a curved surface to the anode.

The detector may comprise a voltage source arranged to provide the first, second and third potentials.

According to a second aspect of the present invention there is provided a method of manufacturing a radiation detector for detecting radiation, the method comprising: providing a housing containing an ionisable gas; providing an array of anode wires extending substantially in a first plane, and arranged to be held at a first potential for attracting electrons; providing at least one cathode wire spaced in a predetermined relationship from the anode wires, and arranged to be held at a second, lower potential; wherein the method further comprises providing at least one additional electrode positioned adjacent a periphery of the array of anode wires, and arranged to be held at a third potential, greater than the second potential.

According to a third aspect of the present invention there is provided a method of detecting radiation using a detector comprising: a housing containing an ionisable gas; an array of anode wires extending substantially in a first plane; at least one cathode wire spaced in a predetermined relationship from the anode wires; and at least one additional electrode positioned adjacent a periphery of the array of anode wires; the method comprising: holding the array of anode wires at a first potential for attracting electrons; holding the at least one cathode wire at a second, lower potential; holding the at least one additional electrode at a third potential, greater than the second potential; measuring the voltages induced on said at least one cathode by electrons collected on the array of anode wires.

The method may comprise the steps of: irradiating a sample of tissue with x-ray radiation; measuring x-ray radiation diffracted from the sample using the detector; and analysing the voltages induced on said cathode wire, for determination if said tissue contains a benign or a malign tumour.

According to a fourth aspect of the present invention there is provided a window for a radiation detector comprising a housing containing an ionisable gas, the window comprising: a layer formed of an electrically conductive material forming an electrode; a layer formed of a plastic, arranged to support the layer formed of electrically conductive material; and a layer of gas impermeable material.

Providing such a layer structure allows the provision of a relatively thin conductive material for providing the electric drift field, with the mechanical support for that layer being provided by the additional plastic layer. Such a window need not include beryllium as the electrically conductive material, and can thus avoid the disadvantages associated with the use of beryllium.

The electrically conductive material may have an electrical conductivity of at least 3.4×10⁵ cm⁻¹Ω⁻¹.

The layer of electrically conductive material may be less than 20 μm thick.

The layer of electrically conductive material may be between 4 μm and 10 μm.

The electrically conductive material may comprise aluminium.

Said plastic may comprise a polyacrylate.

Said polyacrylate may comprise polymethylmethacrylate.

The gas impermeable material may comprise a polyester.

Said polyester may be polyethyleneterephthalate.

The window may be substantially transparent to at least a predetermined range of X-rays.

According to a sixth aspect of the present invention there is provided a radiation detector comprising a housing containing an ionisable gas; and a window in the housing as described above.

Preferably, the radiation detector is a radiation detector as described above, with the window in the housing being substantially transparent to said radiation.

According to a seventh aspect of the present invention there is provided a method of manufacturing a window for a radiation detector, comprising a housing containing an ionisable gas, a method comprising: providing a layer formed of an electrically conductive material forming an electrode; providing a layer formed of a plastic, arranged to support the layer formed of electrically conductive material; and providing a layer of gas impermeable material.

Embodiments of the invention will now be described by way of example only, with reference to the accompanying drawings, in which:

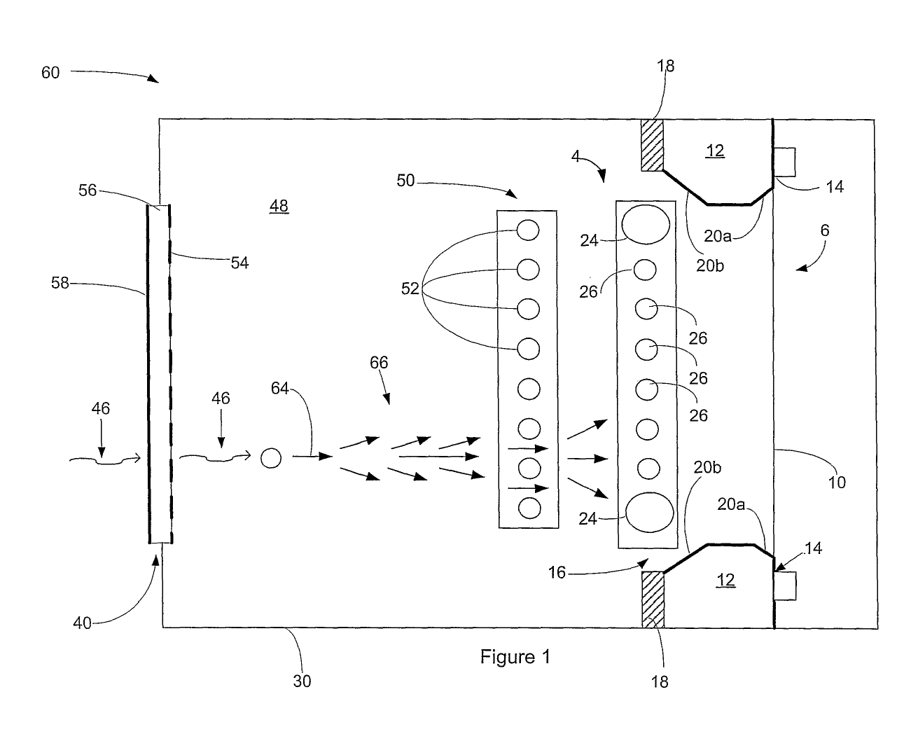

FIG. 1 illustrates a schematic cross-sectional view of an X-ray detector incorporating an electrode configuration in accordance with an embodiment of the present invention;

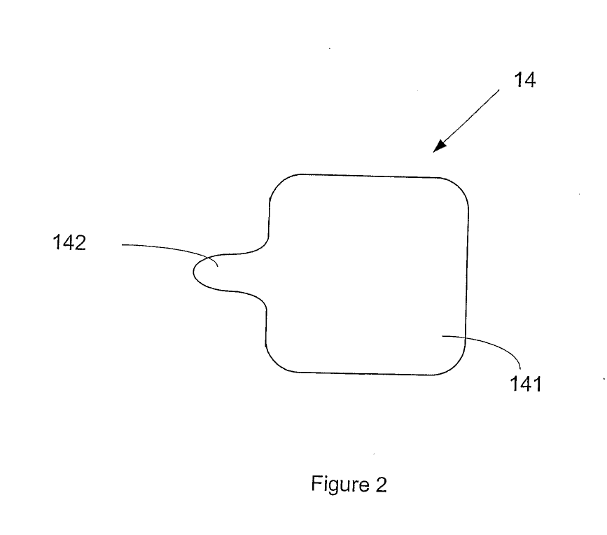

FIG. 2 is a plan view of a pad for coupling an anode or cathode wire to a supporting frame;

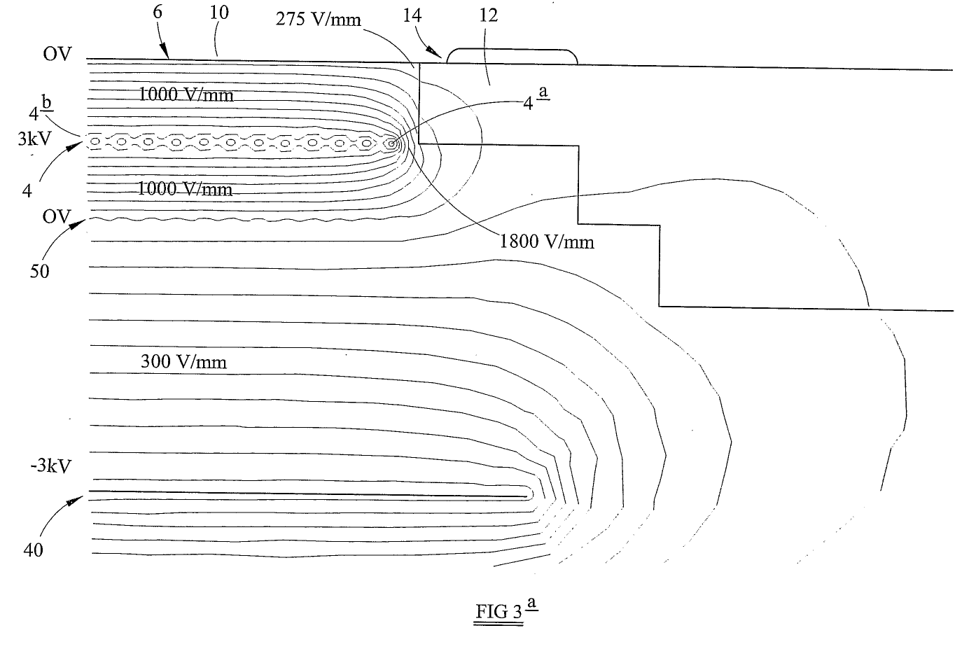

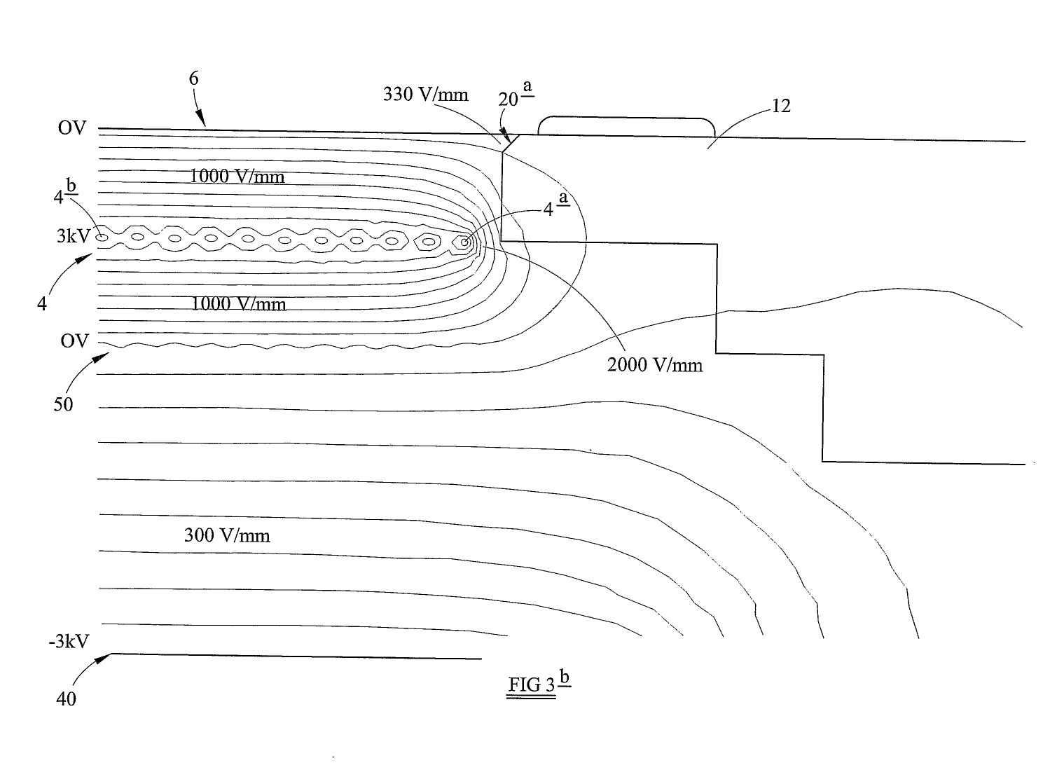

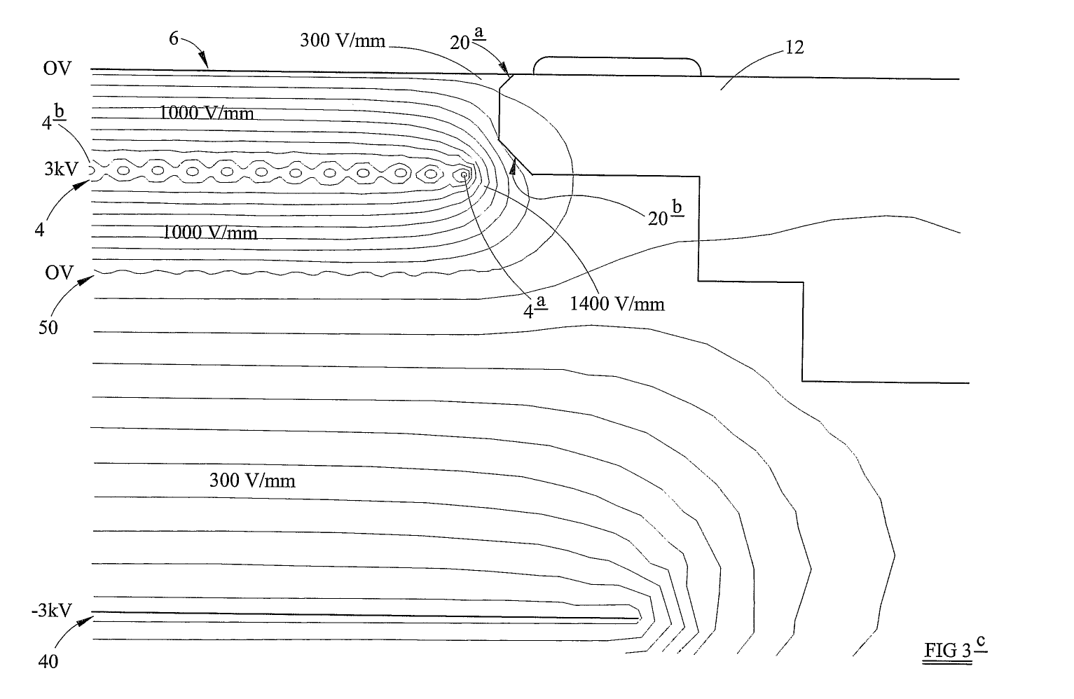

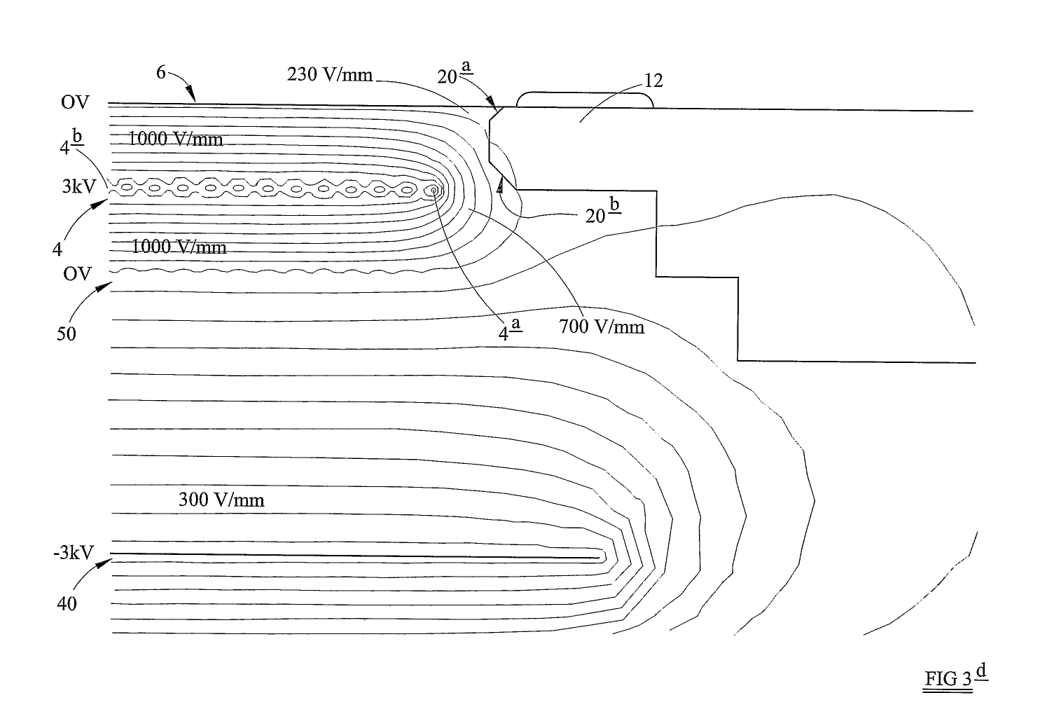

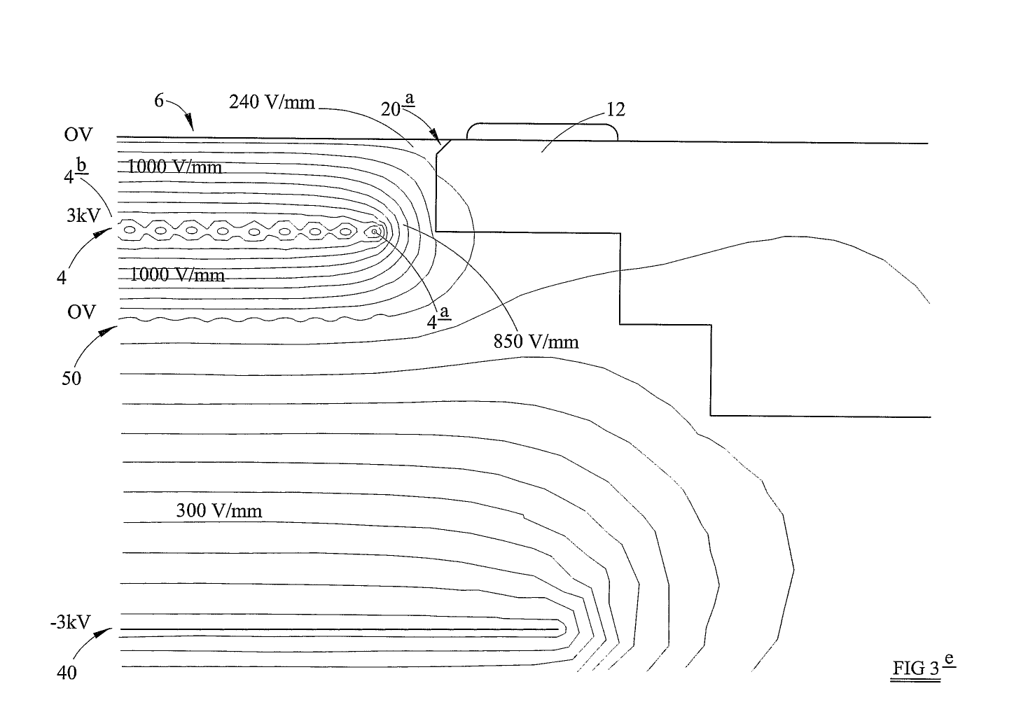

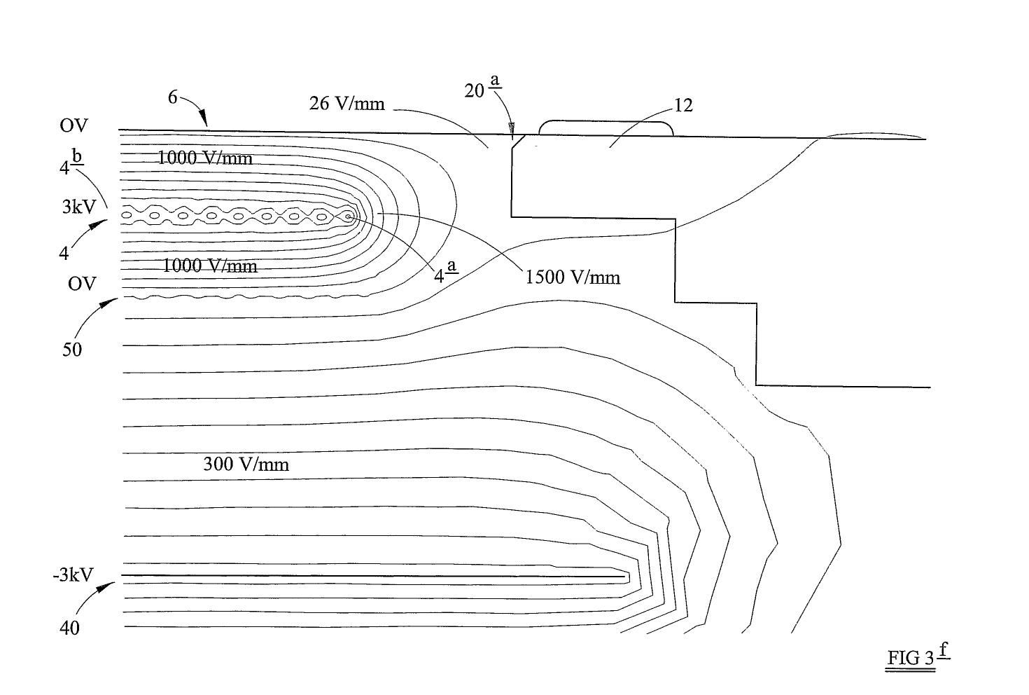

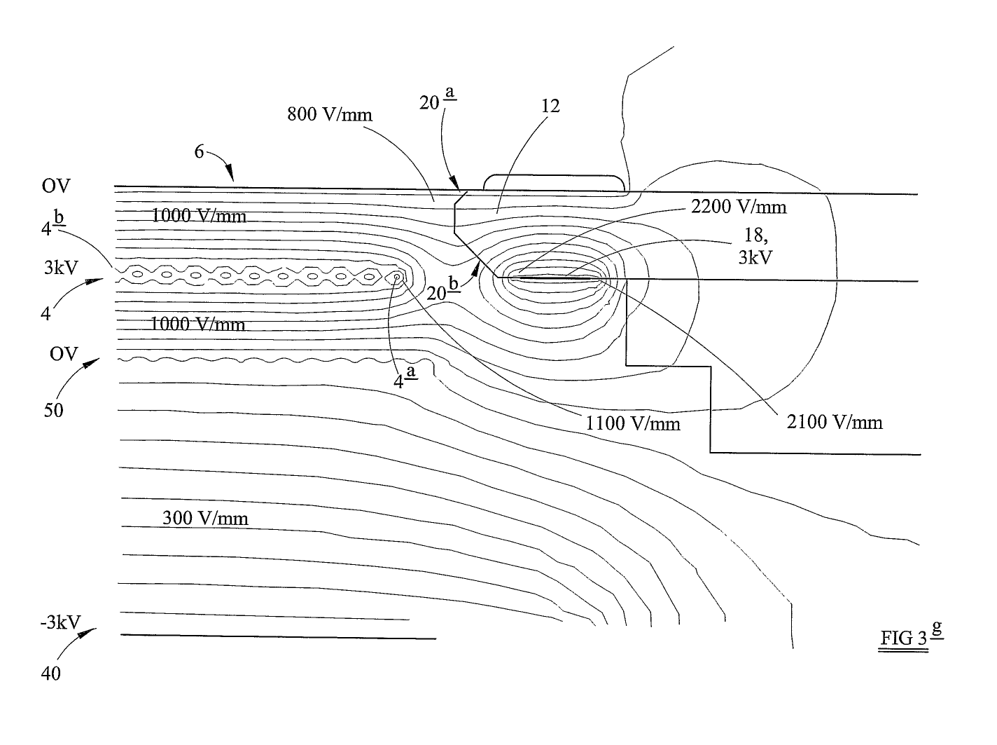

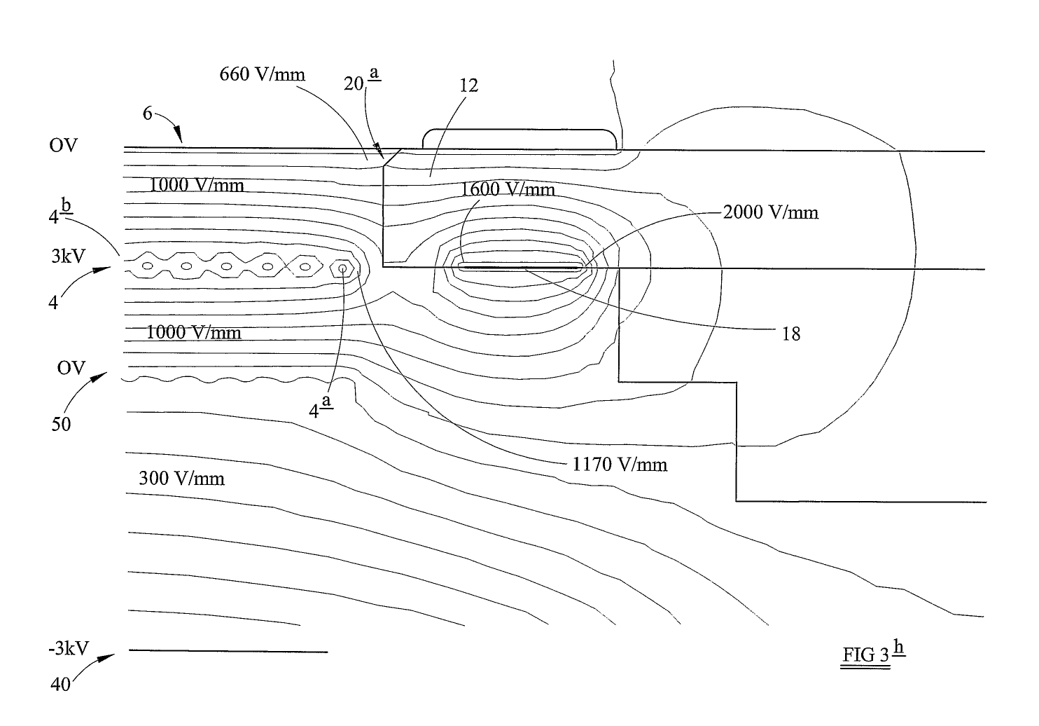

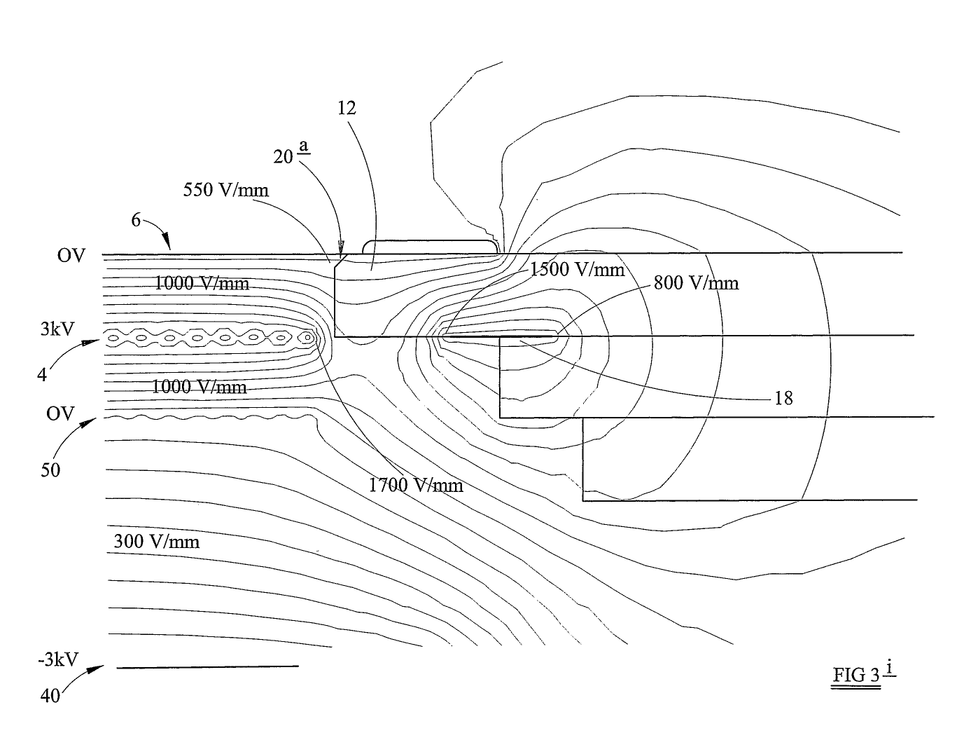

FIGS. 3a-3k illustrate schematic cross-sectional views of different electrode and surrounding structure configurations, illustrating the different electric field distributions; and

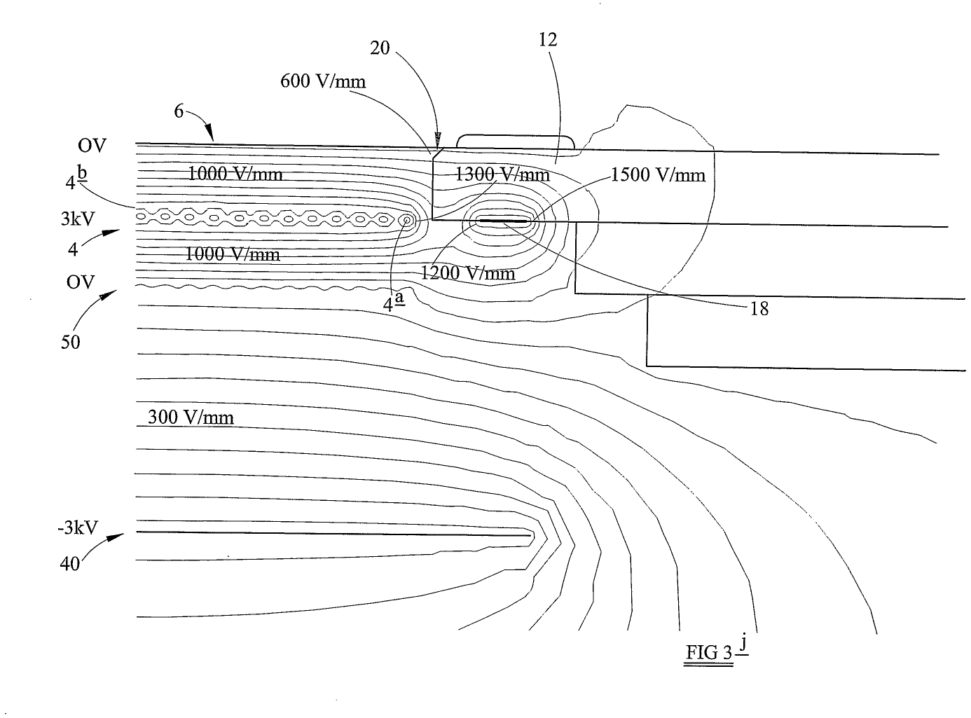

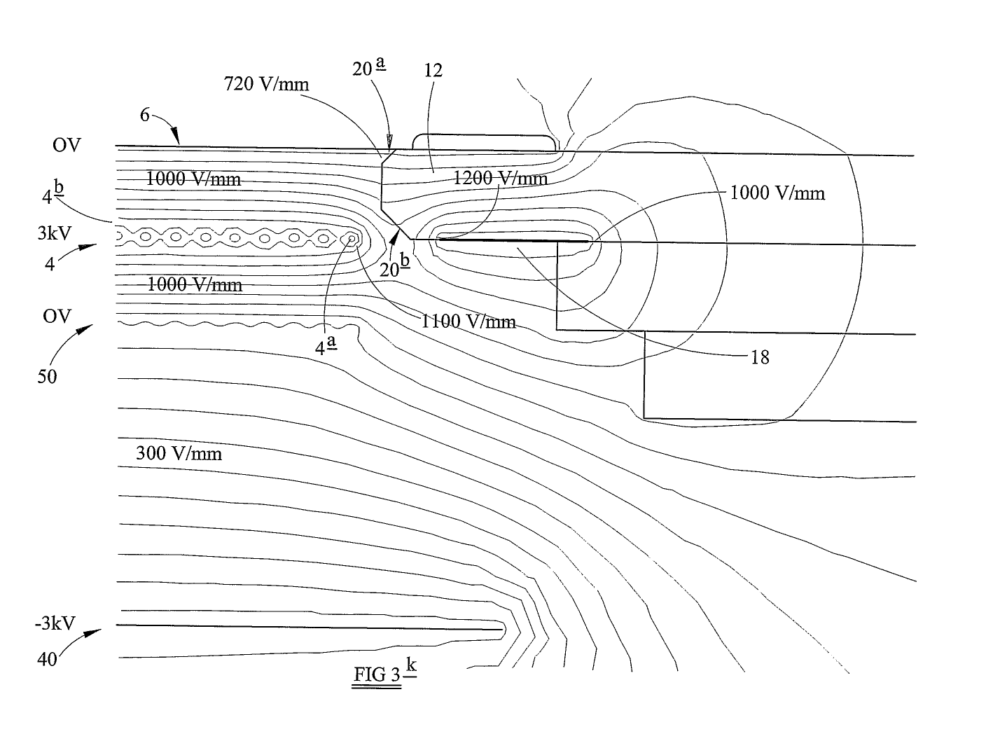

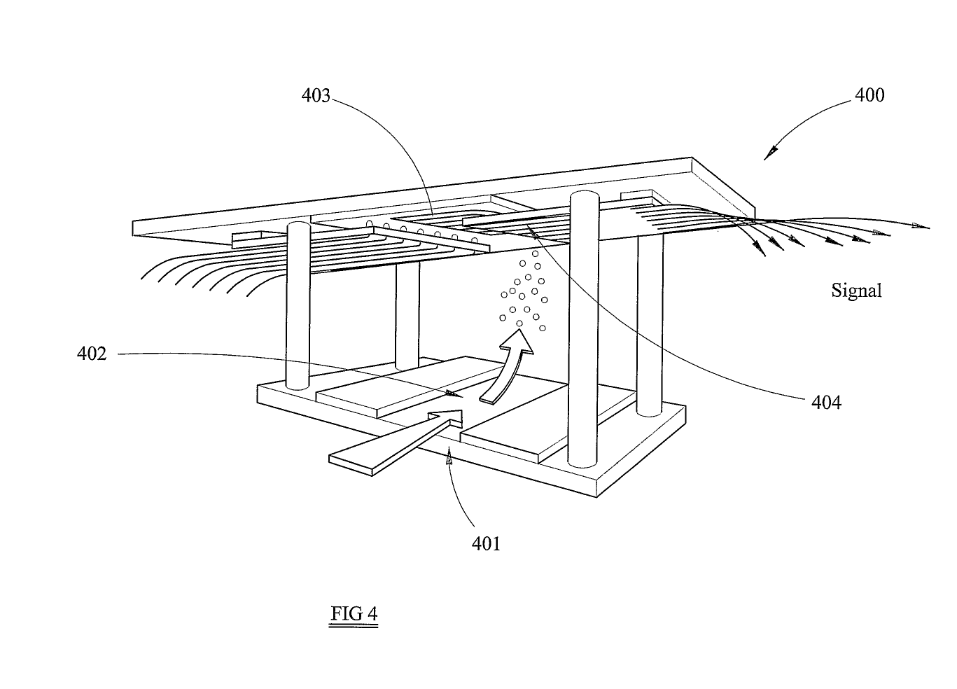

FIG. 4 is a schematic perspective view of an ionising particle analyser incorporating an electrode configuration in accordance with an alternative embodiment of the present invention.

The present inventors realise that there are two positions within such detectors where control of the electric field gradient is particularly important. One position is the edges of the drift field region, where large non-linearities occur in the position mapping of the X-ray interaction point, if the field is not uniform. The other position is the volume around the edges of the anode wire array. If the electric field gradient is not controlled properly in this position, small discharges (i.e. sparking) may occur, leading to a noisy output signal from the detector, as well as unreliable operation of the detector. The present inventors have realised ways in which these problems can be addressed.

FIG. 1 illustrates an X-ray detector 60. The X-ray detector 60 includes a housing 30 containing an ionisable gas 48. Typically, the ionisable gas will comprise a mixture of noble gases (e.g. Argon and Xenon). A relatively small proportion of other gases (such as carbon dioxide, isobutene, or methanedimethylether) may also be provided, to absorb UV (ultraviolet) radiation. Typically, ultraviolet radiation is released as a bi-product of the electron avalanche. These other gases can act to quench unwanted sparking around the anode.

An anode array 4 consists of a plurality of parallel anode wires 24, 26. The wires 24, 26 are equally spaced. The typical spacing between adjacent anode wires is 1 mm. Each wire is approximately 200 mm long. Approximately 200 parallel anode wires are utilised so as to cover a 200 mm×200 mm area. It will be appreciated that these numbers and dimensions are indicative of a particular embodiment of the present invention, and that other embodiments can incorporate different numbers and sizes of wires, so as to provide an array of wires covering a different area. For instance, detector areas (e.g. the area covered by the anode wire array) can vary from being of the order of millimetres to several metres along each side. Each wire is of a substantially continuous uniform diameter. Each wire is normally formed of the same material. However, different wires may be of different diameters.

Preferably, the wires at the centre of the array are thinner than the wires at the ends of the array. The thickness (e.g. diameter for a circular wire) of the wires across the array may taper gradually, with the centre wires being thinnest and the wires at the edge of the array being thickest. Alternatively, each of the wires across the array may generally be of uniform thickness, with only the one or two wires adjacent each end of the array being of greater thickness. Typically, the thickness of the wires at the end of each array will be at least 50% greater than the thickness of the wires in the centre of the array, but may be 100%, or even 400% thicker. For example, the wires at the centre of the array could be of a thickness 10 μm, with the wires at the ends of the array of thickness 20 μm, or even 50 μm. Typically, the wires at the end of the array will be held under a higher tension. The additional tension, as well as the additional stiffness of these wires, serves to mitigate the effects of the forces on the end wires due to the asymmetric field that occurs at the ends of the array.

In this particular embodiment, cathode arrays 6, 50 are located on each side of the anode array. Each cathode array 6, 50 comprises a plurality of parallel, equally spaced wires 10, 52. Each wire 52 within the first cathode array 50 extends within a common plane. Equally, each wire 10 within the second anode array 6 extends within a common plane. The wires 52 in the first cathode array 50 are orthogonal to the wires 10 in the second cathode array 6. The planes of the cathode arrays are parallel to the plane of the anode array 4. A cathode array is placed on each side of the anode array. The cathode arrays are held at a lower electrical potential than the anode array. For instance, the wires in each cathode array are typically held at approximately 0 volts.

As shown in FIG. 1, the wires in the anode array and the wires in the first cathode array are parallel, extending out of the page of the Figure, while the wires 10 in the second cathode array 6 extend along the length of the page.

The wires in each anode and cathode array will normally be held in place by a respective frame. Typically, each frame will be rectangular. The frames are generally stacked, one on top of the other. The frames are formed of a non-conducting material, such as fibreglass. For instance, the frames could be formed of a material known as “FR4”. FR4 laminate is a common material, from which plated-through-hole and multi layer printed circuit boards can be constructed. “FR” indicates that the material is flame retardant, and Type “4” indicates the material is a woven glass reinforced epoxy resin. Once set, the fibre/epoxy composite is strong and readily machinable. The mechanical loads on the wire frame boards, when fully populated with wires, are high. Low creep is therefore an important requirement for the frame material.

Preferably, the resin has a low gassing out property. As the detectors are filled with a gas mixture and then sealed for relatively long periods, it is desirable that no contamination of the ionisable gas occurs from volatile components in the wire frame boards over a period of weeks. The resin used to form the boards is preferably type-PX157C, or an equivalent.

The wires are coupled to the frame via mounting members. Each end of each wire is attached to the frame via a respective mounting member. The mounting members are typically formed of a conductive material, such as copper. The mounting members are commonly called “landing pads”. The landing pads are in turn coupled to an electrical or electronic system, for maintaining the wire at the desired voltage. The electrical or electronic system can also be used to read out signals from the wires, as described below. Typically, each pad will be glued to the frame.

FIG. 2 shows a plan view of a typical landing pad. The shape of the landing pad has been selected so as to facilitate the attachment of the wire to the pad. Firstly, the pad design facilitates determining the lateral position of the wires, and secondly the shape of the pad allows a smooth solder joint to be formed.

The landing pad is typically a planar element. The landing pad 14 comprises a body portion 141, with a projection 142 extending away from the body portion. The projection 142 is centrally located along one side of the body portion 141. The body portion in this example is substantially square. However, the body portion may be rectangular, or even circular. Preferably, any corners of the landing pad are rounded or smooth. The projection 142 facilitates the alignment of the wire, prior to the wire being coupled to the landing pad e.g. via soldering. The wire is aligned with the longitudinally extending projection 142, with the solder joint subsequently being formed on the body portion 141.

X-rays enter the housing 30 via a window 40. The window 40 is transparent to X-rays i.e. it allows a substantial portion of the X-rays 46 to be transmitted through the window. The X-rays 46 act to ionise gas molecules, to produce electrons 64. The anode wires 24, 26 are held at a high potential e.g. 2 kV. The electrodes are thus attracted towards the positive anode, due to the electric field created by the anode wires being held at a high potential. These electrons ionise further gas molecules, to increase the number of electrons 66 attracted towards the anode array 4.

The majority of the electrons created by the ionisation of the gas 48 are collected on the anode wires 24, 26, leaving a net positive charge in gas due to the positive ions. This positive charge induces a voltage on the adjacent cathode wires, which is inversely related to the distance of each cathode wire from the positive charge. Thus, the position of the positive charge in one dimension can be determined by comparing the voltage induced on each wire in a cathode array. This comparison is typically performed using the known delay line readout technique. Alternatively, an analogue to digital converter can be utilised to read the voltage on each wire, and hence determine the position of the positive charge. By comparing the voltage profiles from each orthogonal array of cathode wires, a two-dimensional position of the net positive charge can be obtained i.e. the position of electrons impacting on the anode can be determined by the electrical or electronic system from the voltages induced on the cathode wires, as a function of time.

The row of fine anode wires is held at an electric potential, which will form strong electric fields within a few radii of the surface of each wire. The fields will be above the threshold required for secondary ionisation of the gas molecules—typically this is around 10⁶ volts metre⁻¹. The electric field falls off following an inverse logarithmic function of the radial distance from the centre of the wire, out to several wire radii. The logarithmic function breaks down at large distances from the wire.

In the centre of the anode array, the electric field strength is controlled by the planes of cathode wires, which effectively provide a single sheet of conductor (at least on the scale of many anode wire radii).

However, at the edges of the anode array, the electric field strength is not controlled effectively by the cathode wire arrays. If left uncontrolled, the electric field strength is uneven around the edges of the anode array, resulting in regions of high gain and thus instability. This is undesirable, as it can lead to sparking, with the high gain also resulting in anomalous results for electrons affected by the high gain region.

Additional electrodes 18 are located inside of the anode wires, and extending parallel to the anode wires. These electrodes 18 are held at a potential of a similar magnitude (e.g. between 50% and 150%) of the potential of the anode wires. Preferably, the potential of the additional electrodes is slightly less, or approximately equal to the potential of the anode wires (e.g. between 75% and 100% of the potential of the anode array). For example, if the anode wires are held at 3 kV, then the additional electrodes 18 are held at high potential of 2.5 kV.

By introducing such additional electrodes 18, the electric field in the vicinity of the periphery of the anode array 8 is reduced. The electrodes 18 achieve this by defining a potential in space at a point remote from the regions where it is desirable to control the electric field. The utilisation of the additional electrodes 18 therefore reduces the likelihood of sparking, and improves the uniformity of the electric field. It should be noted that the additional electrodes 18 are preferably in contact with the adjacent frame (e.g. frame 12 of cathode array 6). This reduces the likelihood of sparking occurring. Further, preferably the additional electrodes 18 are charged by the same power supply as the anode array 8, so as to avoid one being raised to a high potential, whilst the other remains in an uncharged state (thus increasing the likelihood of sparking). A potential divider may be utilised to ensure that the additional electrodes 18 are charged to the desired potential relative to that of the anode wires 24, 26 of the anode array 4.

Preferably, none of the frames define any sharp points, edges or corners, to ensure that no sharp edges or corners are presented to the anode. This decreases the likelihood of sparking occurring.

The frame 12 used to locate the wires 10 of the second cathode array 6 is illustrated in FIG. 1. It will be observed that a chamfer 20a, 20b is introduced on each internal surface of the frame. This chamfer acts to reduce the electric field concentrations at the edges of the aperture defined by the frame, so as to reduce sparking. For convenience, the additional electrodes 18 are mounted on the frame 12. These additional electrodes 18 extend parallel to the anode wires. As the additional electrode 18 is held at a similar potential to the anode wires, it serves to reduce high electric field regions at the edges of the anode array. This is achieve by the additional electrodes defining the potential in space at a point remote from the areas where the electric field is required to be controlled. The result is that the electric field distribution is more even. Further additional electrodes may also be provided adjacent to each end of the anode wires, but extending perpendicular to the anode wires. Again, these further additional electrodes can be held at a similar potential to the anode wires, to reduce high electric field regions at the edges of the anode array.

Unlike the typical prior art windows, the window 40 does not include beryllium. The illustrated window 40 is comprised of a three-layer structure. Each of the different layers is substantially planar and parallel. Each of the individual layers is of substantially uniform thickness. A first layer 54 is formed of an electrically conductive material. Preferably, this electrically conductive material comprises, or is formed of, aluminium. The layer 54 acts as an electrode, and is held at a low potential (relative to the anode 4 and the cathode 6, 50) to provide an electric field between the window and the adjacent cathode (the “drift” field). For example, the electrode formed by layer 54 may be held at a voltage of −3 kV. Preferably, the layer 54 is between 4 μm and 10 μm thick, and more preferably is 6 μm thick. Such a thickness is relatively easy to manufacture, while still being thin enough to allow the transmission of X-rays.

The layer 54 is formed of a material that is relatively transmissive to x-rays. Further, the layer 54 is also formed from material that has a relatively low fluorescence yield i.e. the material does not fluoresce to such a degree, that the photons emitted by the fluorescence process significantly interfere with the radiation detection. Although the layer 54 is preferably formed of aluminium, it could alternatively be formed of gold or copper. Aluminium has an electrical conductivity of approximately 3.77×10⁵ cm⁻¹Ω⁻¹, whilst gold has an electrical conductivity of 4.52×10⁵ cm⁻¹Ω⁻¹, and copper has an electrical conductivity of 5.96×10⁵ cm⁻¹Ω⁻¹.

An additional plastic layer 56 is provided to support the electrically conductive layer 54. Such a layer can be formed of any plastic material that is substantially transmissive to X-rays, for instance PMMA (polymethylmethacrylate). The window is impermeable to gases, so as to prevent gases 48 leaking from the housing 30 and prevent ingress of atmospheric gases. Typically, an additional layer 58 will be provided to provide this gas impermeability. The additional layer may be formed from a polyester, such as polyethyleneterephthalate (e.g. Mylar). Typically, the plastic layer 56 arranged to provide mechanical support for the electrically conductive layer 54 will be less than 20 mm thick, and even more preferably between 4 and 5 mm thick. In some instances, the plastic layer 56 may act as the gas impermeable layer 58.

The layers 54, 56 and 58 may be glued together. The layers 54, 56 and 58 may be assembled to form the window 40 by a vacuum press process. Firstly, the layers are squeezed together, to facilitate the expelling of any gases from the structure. Glue sheets are placed between the layers. The structure is heated so as to permanently adhere the layers together. Preferably, the squeezing together and the heating of the layers are performed simultaneously under vacuum, so as to facilitate the removal of any gases expelled from the structure. Typically, once finished the window will be at least 50% transparent to X-ray photons, and more typically it will pass over 80%, (or even 87%) of the X-ray photons that it is desirable to detect e.g. X-rays of energies 8 keV.

In similar embodiments, the electrically conductive layer 54 may be AC grounded to provide screening from electromagnetic interference. Alternatively, the window may comprise an additional layer of an electrically conductive material, which is AC grounded to provide screening from electromagnetic radiation.

To facilitate an understanding of the electric field strength distribution within the detector, a variety of different electrode configurations (for the anode and cathode layers) will now be described with reference to FIG. 3a-3k. Each figure shows one half of a detector electrode arrangement, including the adjacent supporting frame structure of one cathode array. In each FIG. 3a to 3k, it is assumed that the anode array is held at a potential of 3 kV, both cathodes at 0 V, and the electrode of the window at −3 kV. Various electric field strength values (in V mm⁻¹) are indicated within each figure, to provide examples of the approximate electric field strength at various positions.

FIG. 3a shows a typical anode/cathode arrangement for use in a radiation detector. FIG. 3a shows a first a cathode wire 10 coupled via a pad 14 to a frame 12, the wire extending within the plane of the drawing and perpendicular to the plurality of wires that form the anode array 4. Also shown are contour lines. Each contour shows where the electric field is the same strength. The closer the contour lines, the greater the gradient of the electric field. For example, the lines are tightly bunched around the periphery of the anode 4, indicating that the electric field gradient in that region is relatively large.

The field gradient is high between the periphery/end of the anode 4a and the frame 12, as the frame 12 is an insulator. Thus, sparking is likely to occur at the periphery, even though the electric field gradient in the vicinity of the centre 4b (i.e. away from the periphery) of the anode array may be insufficient to cause sparking.

The ideal anode/cathode arrangement is to have a uniform electric field i.e. the electric field strength at any predetermined distance from the anode being of the same magnitude, irrespective of position along the anode array.

FIG. 3b shows a similar anode/cathode arrangement to that shown in FIG. 3a, except that the frame 12 has a chamfered edge 20a adjacent to the cathode wire. Introducing the chamfered edge causes the gradient of the electric field to decrease. This results in the strength of the electric fields at the midpoints between the anode and the frame, and the cathode and the frame, increasing (from 1800 Vmm⁻¹ to 2000 Vmm⁻¹ and from 275 Vmm⁻¹ to 330 Vmm⁻¹ respectively). Thus, the field is more uniform between the anode and the frame.

FIG. 3c shows a similar anode/cathode arrangement to that shown in FIG. 3b, except that the frame has an additional chamfered edge 20b adjacent to the anode. By removing the corner edge from the frame, the strength of the electric field between the anode and frame is reduced by 400 Vmm⁻¹ (from 1800 Vmm⁻¹ to 1400 Vmm⁻¹), i.e. the field is less uniform.

FIG. 3d shows a similar anode/cathode arrangement to that shown in FIG. 3c, except that a single outermost wire of the anode array has been removed i.e. the anode array is effectively further away from the frame. The strength of the electric field between the anode and the frame and between the cathode wire and the frame is reduced, to 700 Vmm⁻¹ and to 230 Vmm⁻¹ respectively

FIG. 3e shows a similar arrangement to that shown in FIG. 3d, but with no chamfer on the frame surface adjacent the anode i.e. the adjacent frame corner edge is present. The strength of the electric field between the anode and the frame (850 Vmm⁻¹) is increased.

FIG. 3f shows a similar anode/cathode arrangement to that shown in FIG. 3b, except that the outermost five anode wires have been removed, as well as the front five cathode wires on array 6. The strength of the electric field between the anode and the frame has been decreased (compared with that shown in FIG. 3b) to 1500 Vmm⁻¹, and the field strength between the cathode wire and the frame is reduced to 26 Vmm⁻¹.

FIG. 3g shows a similar anode/cathode arrangement to that shown in FIG. 3f, except that an additional electrode 18 has been introduced. The additional electrode 18 is 3 mm wide and raised to a potential of 3 kV i.e. the same potential as the anode. The shape of the electric field between the anode and the frame has been dramatically changed. As can be seen from the drawing the field is largely uniform, with the field strength being 1100 Vmm⁻¹ between the anode and frame and 800 Vmm⁻¹ between the cathode and frame. It is unlikely sparking will occur between the anode and the additional electrode. Sparking does not occur between the additional electrode 18 and the frame 12, as the frame is an insulator.

FIG. 3h shows a similar anode/cathode arrangement to that shown in FIG. 3g, except there is no chamfered edge adjacent to the anode. A corner (sharp) edge is adjacent to the anode. Further, all of the anode wires are in place (i.e. the anode wires are in the same position relative to the frame as shown in FIG. 3a).

FIG. 3i shows a similar anode/cathode arrangement to that shown in FIG. 3h, except that the additional electrode 18 has been moved away from the periphery of the anode but remains co-planar. The additional electrode 18 has thus been moved towards a portion of the frame supporting the anode array, so that it is partially enclosed between the cathode frame 12 and the anode frame structure. The resulting electric field strength is increased in the vicinity of the periphery of the anode (1700 Vmm⁻¹), and therefore the field created is less uniform that the field created by the arrangement shown in FIG. 3h

FIG. 3j shows a similar anode/cathode arrangement to that shown in FIG. 3h, except that the additional electrode has been reduced in width to 2 mm, centralised on the lower exposed surface of the frame 12, and the potential applied to the additional electrode has been reduced to 2500V i.e. less than the potential applied to the anode array. The resulting electric field strength is substantially increased in the vicinity of the periphery of the anode (1300 Vmm⁻¹) and therefore the field is more uniform.

FIG. 3k shows the currently preferred arrangement utilised in FIG. 1. The arrangement of FIG. 3k is the same as FIG. 3h except that: the additional electrode 18 is located 2 mm away from the adjacent edge of the frame 12; the additional electrode 18 extends across the lower surface of the frame 12 (i.e. the frame surface closest to the source of electrons) to be partially enclosed by the frame of the anode array; and the surface of the frame 12 adjacent the anode is chamfered. As in FIG. 3h, all of the wires of the anode array are present and the additional electrode is raised to 2500V. The surface 21a of the frame 12 adjacent the cathode array 6 is chamfered at 45 degrees, and is 1 mm in width. The electric field is substantially uniform, with the field proximal to the periphery of the anode being 1100 Vmm⁻¹, compared with 1000 Vmm⁻¹ proximal to the centre of the anode, and 720 Vmm⁻¹ between the cathode and the frame.

Although the above embodiments have been described with reference to an X-ray detector, in which the X-rays directly ionise some of the gas modules 48, it will be appreciated that embodiments of the present invention can be employed in other radiation detectors.

For instance, FIG. 4 illustrates an ionising particle analyser 400, such as that described in granted U.S. Pat. No. 6,452,401. In the embodiment of the radiation detector 400 shown in FIG. 4, X-rays 401 enter the housing containing an ionisable gas. X-rays 401 impact on the surface of the sample 402, resulting in electrons being emitted from the surface of the sample 402. As in the embodiment shown in FIG. 1, such electrons will be multiplied due to the electric field set up by the anode array 403. The electrons are accelerated towards, and collected by, the positive anode 403. At least one cathode array 404 adjacent to the anode is utilised to detect the resulting net positive charge in the gas due to the positive ions. The X-rays 401 enter the housing of the detector 400 via a window having the same features as described with respect to the window 40 in FIG. 1. Further, the anode and cathode arrangement 403, 404 is the same as that described with respect to the anode 4 and cathode 50 arrays illustrated in FIG. 1.

Embodiments of the present invention may be utilised to perform a variety of experiments/analytical techniques. For instance, a radiation detector as described herein is particularly appropriate to measure diffraction patterns of collagen. Collagen occurs within the inter-cellular matrix of animal tissue, the term animal tissue including human tissue. In normal tissue collagen, the collagen is “fibrous” and thus has a clear diffraction pattern. However, in tumorous tissue, the collagen structure breaks down, with a resulting degradation in the diffraction pattern. The diffraction patterns from malign and benign tumours are subtly different.

In order to perform an accurate diagnosis as to whether tumorous tissue is malign or benign, it is necessary to use a radiation detector with high sensitivity and good signal to noise capability e.g. a radiation detector as described herein.

The tissue sample is located adjacent the detector, to allow the detector to measure the distribution in the intensity of the x-rays diffracted by the tissue sample i.e. to measure the diffraction pattern of the tissue sample. Analysis of the resulting diffraction patterns can be utilised to determine whether the tissue contains malign or benign tumours. For instance, this can be done by comparing the diffraction pattern(s) obtained from a particular sample with a library of earlier experimental results, or by a skilled person looking at the diffraction pattern.

Such a technique allows a tumours to be directly diagnosed, without requiring extensive and time-consuming laboratory preparation for biochemical analysis.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A detector for detecting radiation, comprising:
a housing containing an ionisable gas;
an array of anode wires extending substantially in a first plane, and arranged to be held at a first potential for attracting electrons;
at least one cathode wire spaced in a predetermined relationship from the anode wires, and arranged to be held at a second, lower potential;
wherein the detector further comprises at least one additional electrode positioned adjacent a periphery of the array of anode wires, and arranged to be held at a third potential, greater than the second potential.

2. A detector as claimed in claim 1, wherein said third potential is less than or substantially equal to said first potential.

3. A detector as claimed in claim 1, wherein the at least one additional electrode comprises a first additional electrode positioned adjacent one edge of the array of anode wires, and a second additional electrode positioned adjacent the opposite edge of said array.

4. A detector as claimed in claim 1, wherein said at least one additional electrode extends substantially within the first plane.

5. A detector as claimed in claim 1, wherein each of said anode wires extends in a substantially parallel direction, and
said at least one additional electrode extends longitudinally in a direction parallel to the anode wires.

6. A detector as claimed in claim 1, wherein each of said anode wires extends in a substantially parallel direction, and said at least one additional electrode extends longitudinally in a direction perpendicular to the anode wires.

7. A detector as claimed in claim 1, wherein the anode wires located at each end of the array are thicker than the anode wires located at the centre of the array.

8. A detector as claimed in claim 7, wherein the anode wires located at each end of the array have a thickness at least 50% greater than the thickness of the anode wires located at the centre of the array.

9. A detector as claimed in claim 1, wherein the anode wires located at each end of the array are held under greater tension than the wires located at the centre of the array.

10. A detector as claimed in claim 1, further comprising at least one frame supporting at least one of said anode or cathode wires, the supported wire being coupled to the frame via a member coupled to the frame, the member comprising a body portion with a projection extending towards the centre of the length of supported wire.

11. A detector as claimed in claim 1, further comprising at least one frame supporting at least one of said wires, the frame being formed of an electrically insulative material, the separation between said supported wire and an adjacent surface of the frame tapering towards an adjacent end of said wire.

12. A detector as claimed in claim 10 or claim 11, wherein said frame supports at least one of the cathode wires, with the portion of the frame adjacent a periphery of the anode wire array presenting at least one of a substantially planar surface to the anode and a curved surface to the anode.

13. A detector as claimed in claim 1, further comprising a voltage source arranged to provide the first, second and third potentials.

14. A method of manufacturing a radiation detector for detecting radiation, the method comprising: providing a housing containing an ionisable gas;
providing an array of anode wires extending substantially in a first plane, and arranged to be held at a first potential for attracting electrons;
providing at least one cathode wire spaced in a predetermined relationship from the anode wires, and arranged to be held at a second, lower potential;
wherein the method further comprises providing at least one additional electrode positioned adjacent a periphery of the array of anode wires, and arranged to be held at a third potential, greater than the second potential.

15. A method of detecting radiation using a detector comprising:
a housing containing an ionisable gas; an array of anode wires extending substantially in a first plane; at least one cathode wire spaced in a predetermined relationship from the anode wires; and at least one additional electrode positioned adjacent a periphery of the array of anode wires;
the method comprising:
holding the array of anode wires at a first potential for attracting electrons;
holding the at least one cathode wire at a second, lower potential;
holding the at least one additional electrode at a third potential, greater than the second potential;
measuring the voltages induced on said at least one cathode by electrons collected on the array of anode wires.

16. A method as claimed in claim 15, further comprising the steps of:
irradiating a sample of tissue with x-ray radiation;
measuring x-ray radiation diffracted from the sample using the detector; and
analysing the voltages induced on said cathode wire, for determination if said tissue contains a benign or a malign tumour.

17. A window for a radiation detector comprising a housing containing an ionisable gas, the window comprising:
a layer formed of an electrically conductive material forming an electrode; a layer formed of a plastic, arranged to support the layer formed of electrically conductive material; and
a layer of gas impermeable material.

18. A window as claimed in claim 17, wherein the electrically conductive material has an electrical conductivity of at least 3.4×10⁵ cm⁻¹Ω⁻¹.

19. A window as claimed in claim 17, wherein the layer of electrically conductive material is less than 20 μm thick.

20. A window as claimed in claim 19, wherein the layer of electrically conductive material is between 4 μm and 10 μm.

21. A window as claimed in claim 17, wherein the electrically conductive material comprises aluminium.

22. A window as claimed in claim 17, wherein said plastic comprises a polyacrylate.

23. A window as claimed in claim 22, wherein said polyacrylate comprises polymethylmethacrylate.

24. A window as claimed in claim 17, wherein the gas impermeable material comprises a polyester.

25. A window as claimed in claim 24, wherein said polyester is polyethyleneterephthalate.

26. A window as claimed in claim 17, wherein said window is substantially transparent to at least a predetermined range of X-rays.

27. A radiation detector comprising a housing containing an ionisable gas; and a window in the housing, the window comprising a layer formed of an electrically conductive material forming an electrode, a layer formed of a plastic, arranged to support the layer formed of electrically conductive material, and a layer of gas impermeable material.

28. (canceled)

29. A method of manufacturing a window for a radiation detector, comprising a housing containing an ionisable gas, a method comprising: providing a layer formed of an electrically conductive material forming an electrode;
providing a layer formed of a plastic, arranged to support the layer formed of electrically conductive material; and
providing a layer of gas impermeable material.

30. A radiation detector as claimed in claim 1, further comprising a window formed in the housing, the window comprising:
a layer formed of an electrically conductive material forming an electrode;
a layer formed of a plastic, arranged to support the layer formed of electrically conductive material; and
a layer of gas impermeable material.
